(19) United States
(12) Patent Application Publication
(10) Pub. No.: US 2010/0208349 A1
(43) Pub. Date: Aug. 19, 2010

(54) FLEXIBLE MATERIALS FOR OPTICAL APPLICATIONS

(76) Inventors: Robert Beer, Schweiz (CH); Gilbert Gugler, Schweiz (CH); Marc Pauchard, Schweiz (CH); Stefan Schuettel, Schweiz (CH)

Correspondence Address: ONOFRIO LAW, 15 N. MILL STREET - SUITE 225, NYACK, NY, 10960, US

(21) Appl. No.: 12/309,745

(22) PCT Filed: Jul. 28, 2006
(86) PCT No.: PCT/EP2006/064823

§ 371 Date: Jan. 28, 2009

(51) Int. Cl. G02B 1/12; G02B 1/10; B05D 5/06

(52) U.S. Cl. 359/580; 427/162

(57) ABSTRACT

A flexible material for optical applications in a wavelength range of λ₁ to λ₂, λ₁ being smaller than λ₂, composed of a flexible support and at least one multilayer that comprises a porous or nanoporous layer which has a low refractive index and contains inorganic nanoparticles and at least one binder, and a non-porous polymer layer which has a high refractive index and is in direct contact with the porous or nanoporous layer; said flexible material is characterized in that the maximum thicknesses of the boundary layers, in which the refractive index changes from one value to the other and which are located between the porous or nanoporous layers and the non-porous polymer layers that are in direct contact therewith, amount to 0.2 times wavelength λ₂; and the difference in the refractive indices of the porous or nanoporous layers and the non-porous polymer layers is at least 0.20, 200 nm and 2500 nm being typical values for λ₁ and λ₂.

### FIELD OF THE INVENTION

The present invention relates to flexible materials for optical applications, composed of a flexible support and, on said support, at least two thin layers in direct contact. The refractive indices of these two layers differ by at least 0.20. One of these layers is porous or nanoporous and contains inorganic nanoparticles, the other layer is a non-porous polymer layer.

### BACKGROUND OF THE INVENTION

Dielectric thin layers are thin, normally transparent layers consisting of different chemical compounds and typically having layer thicknesses in the micrometer or nanometer range. Dielectric thin layers are used in optical applications in order to change the optical properties of surfaces and boundaries. Incident light is partially reflected and partially transmitted and refracted at such boundaries. The diffraction behavior and the reflection behavior may be efficiently influenced by a suitable choice of materials and layer thicknesses. The thicknesses of interesting layers are situated in a wavelength range of λ₁ to λ₂, which is the interesting wavelength range for a particular application.

So-called λ/4 layers having a thickness of λ/4 are preferably used in anti-reflection coatings and in highly reflecting dielectric mirrors. In the case where the layer thickness is a multiple of λ/4, the desired effect is still present but gradually diminishes with increasing layer thickness.

It is feasible, for example, to prepare an interference filter by using a sequence of layers having high and low diffraction indices, which is transparent only at particular wavelengths. Such interference filters are broadly used as dielectric filters in spectroscopy.

It is also possible to prepare Bragg reflectors by using such multilayer materials that reflect light selectively and nearly completely at a particular wavelength. A reflectivity of more than 99% may be attained. Such a Bragg reflector may be used for the construction of a polymer laser, as described by N. Tessler, G. J. Denton and R. H. Friend in “Lasing from conjugated-polymer microcavities”, Nature 382, 695-697 (1996).

Such interference effects may also be used, for example, for the preparation of “physical colors” that are used in the manufacture of colored sunglasses having an excellent light stability. Physical colors may also be used as optical security elements on currency notes or in product labels.

Using a suitable combination of layers having high and low refractive indices, waveguide devices may be prepared having the property that certain light wavelengths are guided inside these devices into specified zones and may be extracted in a well-defined region. In these waveguide devices, a layer with high diffraction index (core) is surrounded by layers with lower diffraction index (cladding). Light is propagated in the core by total internal reflection. The layer thickness of the core determines which modes of a light wave may be propagated.

Waveguides, wherein only the basic mode is propagated, are called unimodal or single mode waveguides. The layer thickness of the core depends on the diffraction indices of the used materials and the light wavelength range λ₁ to λ₂ that is of interest in a particular application, as described for example by X. Peng, L. Liu, J. Wu, Y. Li, Z. Hou, L. Xu, W. Wang, F. Li and M. Ye in “Widerange amplified spontaneous emission wavelength tuning in a solid-state dye waveguide”, Optics Letters 25, 314-316 (2000). The layer thickness of the core of materials used in glass fibers is typically from 2 to 6 light wavelengths. The layer thickness of the core of a single mode waveguide is lower than one wavelength in the case where the difference of the refractive indices of the layers is above 0.20. With increasing layer thickness of the core, an increasing number of higher modes are propagated. Such a device is called a multimodal waveguide. Single mode waveguides have quite a few advantages in comparison to multimodal waveguides and are preferred for this reason in some applications. It would therefore be very interesting if thin waveguide layers with an elevated difference of refractive indices could be realized. Interesting applications of such waveguides are for example in integrated optical chips for signal propagation or in sensor chips for analysis by interaction with light.

It is a big advantage, in many of the mentioned applications, to have a big difference of refractive indices of two neighboring layers. The refractive index must change abruptly from one layer to the next layer. For example, the necessary number of λ/4 layers in a dielectric mirror may be drastically reduced, at the same level of reflection, by an increase of the difference of the refractive indices of the used layers, as described for example in patent application 2004/0,096,574.

The refractive index of inorganic materials varies from 1.45 (silicate glass) to 3.40 (indium phosphide), as indicated by N. Kambe, S. Kumar, S. Chirovolu, B. Chaloner-Gill, Y. D. Blum, D. B. MacQueen and G. W. Faris in “Refractive Index Engineering of Nano-Polymer Composites”, in “Synthesis, Functional Properties and Applications of Nanostructures”, Materials Research Society Symposium Proceedings 676, pages Y8.22.1-Y8.22.6 (2002), ISBN 1-55899-612-5. It is possible, within rather narrow limits, to change the refractive index of a particular inorganic material by doping. Patent application EP1,116,966 describes how the refractive index of the pure silicate glass may be slightly lowered by doping with B₂O₃ or slightly increased by doping with P₂O₅.

Commonly available organic polymers have refractive indices between 1.34 and 1.66. The polymer having the highest refractive index of 1.76 known up to now is described in U.S. Patent Publication No. 2004/0,158,021.

The refractive indices n of available or characterized organic polymers are listed in Table 1 at a wavelength of 550 nm.

TABLE 1

| Material | n |
|---|---|
| Polytetrafluoroethylene | 1.34 |
| Perfluoralcoxy copolymers | 1.35 |
| Polyvinylidenefluoride | 1.42 |
| Celluloseacetate/butyrate | 1.47 |
| Polymethyl methacrylate | 1.49 |
| Polyvinyl alcohol | 1.50 |
| Cyclic olefins | 1.53 |
| Benzocyclobutene | 1.57 |
| Polycarbonate | 1.59 |
| Polysulphone | 1.63 |
| Polyester | 1.65 |
| Polyimide | 1.66 |
| Polyimide (US 2004/0′158′021) | 1.76 |

Refractive indices above 1.76 may be attained by a suitable combination of organic polymers and of inorganic substances. Y. Wang, T. Flaim, S. Fowler, D. Holmes and C. Planje describe, for instance, in “Hybrid high refractive index polymer coatings”, Proceedings of SPIE 5724, 42-49 (2005) the preparation of a hybrid material containing titanium dioxide and an organic polymer that has a refractive index of 1.94 at a wavelength of 400 nm.

The range of refractive indices between 1.05 and 1.40 may be covered by the use of porous or nanoporous structures containing a high amount of air or other gases within the pores of the layer. U.S. Pat. No. 6,204,202 describes for example the preparation of porous SiO₂ layers having refractive indices between 1.10 and 1.40. These layers are obtained in a sol-gel process and by the use of thermally decomposable polymers. Such polymer containing layers need to be heated for 10 to 60 minutes at a temperature of at least 400° C. in order to decompose the polymer and to obtain pure SiO₂ layers having the desired properties. Aerogels may also be used for the preparation of such porous layers, as described for example by A. Köhler, J. S. Wilson and R. H. Friend in “Fluorescence and Phosphorescence in Organic Materials”, Advanced Materials 14, 701 (2002).

Big differences of refractive indices of different layers, up to a value of 2.00, may be obtained by a suitable combination of non-porous inorganic compounds in the different layers.

Such layers are prepared for example by sputtering in vacuum or in a sol-gel wet process.

U.S. Patent Publication No. 2004/0,096,574 describes, for example, a combination of layers of a dielectric mirror consisting of Al₂O₃ and GaP and having a difference of refractive indices of 1.87.

The difference of refractive indices may be further increased in some cases by suitable combinations of non-porous inorganic layers and non-porous organic layers. However, the number of possible combinations of layers is limited by the restricted compatibility of the compounds and the feasible coating technologies.

Big differences of refractive indices may also be obtained by the combination of non-porous organic layers and porous or nanoporous inorganic layers. Such an example is described by R. L. Oliveri, A. Sciuto, S. Libertino, G. D'Arrigo and C. Arnone in “Fabrication and Characterization of Polymeric Optical Waveguides Using Standard Silicon Processing Technology”, Proceedings of WFOPC 2005, 4th IEEE/LEOS Workshop on Fibres and Optical Passive Components, pages 265-270 (2005). Here, a porous SiO₂ layer having a low refractive index is prepared on a silicium chip and polymethylmethacrylate is used in the layer having a high refractive index

All these inorganic layers mentioned above are brittle and have only a very restricted mechanical flexibility. Such materials may be used only in circumstances where a very big difference of refractive indices is required and where mechanical stability is not important.

The porous layers mentioned before, used in optical applications, also do not have the required mechanical properties and, further, unsuitable steps are sometimes necessary in manufacture (high temperature treatment, supercritical drying etc.). They are therefore not suitable for cheap, big-scale manufacture on flexible supports.

A high mechanical flexibility of the produced layers is necessary for certain applications. Flexible layers may be obtained by applying solutions of suitable organic polymers or of melts of suitable polymers. Patent application JP 2005-055,543 describes a method for the preparation of polymer multilayers for optical applications. The number of realizable combinations of layers is limited, however, also in this case by the restricted compatibility of the compounds (adhesion, solubility in different solvents etc.) and the problem of precise multilayer coating. The realizable difference of refractive indices is therefore far below the theoretical value of 0.42, which may be calculated from the combination of the polymer with the lowest refractive index (polytetrafluoroethylene with a refractive index of 1.34) and the polymer with the highest refractive index (polyimide with a refractive index of 1.76). For example, the highest realized difference of refractive indices in patent application JP 2005-055,543 is 0.20.

Porous or nanoporous ink-receiving layers containing inorganic nanoparticles and a small amount of binder are used in rapidly drying recording sheets for ink jet printing. Such layers have a high mechanical flexibility.

Recording sheets for ink jet printing having, on a flexible support, a flexible layer containing inorganic nanoparticles and, on top of this layer, a polymer layer, are also known. Such recording sheets, incorporating a non-porous polymer layer, are described for example in patent applications EP 1,188,572 and EP 1,591,265, wherein the thickness of the polymer layer is normally from 3 μm to 15 μm. The layer thickness may not be below 3 μm, because, otherwise, the required ink absorption properties of the polymer film would not be guaranteed.

A recording sheet with a porous polymer layer is described, for example, in patent application EP 0,761,459. In this case, the recording sheet is heated after printing in order to seal the porous polymer layer and to protect in this way the image situated below.

In U.S. Pat. No. 6,025,068, the polymer film is applied after printing of the recording sheet by coating of a polymer solution, or the polymer film is laminated onto the printed recording sheet with the help of a an adhesion-promoting agent.

Suitable polymer layers for optical applications need to have a thickness that is situated in the range of about a quarter to one wavelength of the used light.

The quality of the always present boundary layer between the porous or nanoporous layer and the polymer layer as well as the homogeneity of the polymer layer are not sufficiently good for optical applications. In recording sheets for ink jet printing, a too sharp boundary layer would be annoying for the reason of undesirable colour effects.

An optical intensifying material is described in patent application EP 1,492,389, wherein a thin, transparent intensifying layer containing nanocrystalline, nanoporous aluminum oxides or aluminum oxide/hydroxides and, optionally, a binder, and, on top of this layer, a luminescence layer, preferably consisting of tris(8-hydroxyquinoline) aluminum, are coated onto a support. The luminescent compound is deposited by sputtering and the resulting luminescence layer has a sufficient mechanical flexibility only at a thickness below 200 nm.

### SUMMARY OF THE INVENTION

Accordingly it is an objective of the invention to provide flexible materials for optical applications, composed of a flexible support and at least two layers in direct contact, having a big difference of their refractive indices, on said support. These materials have a high mechanical flexibility and may be manufactured in a cost-efficient manner in high quantities.

Surprisingly, we have found that this objective may be attained by suitable combinations of porous or nanoporous layers containing inorganic nanoparticles and having a low refractive index, with non-porous polymer layers having a high refractive index.

Other objects, features and advantages of the present invention will be apparent when the detailed description of the preferred embodiments of the invention are considered with reference to the drawings which should be construed in an illustrative and not limiting sense as follows:

### BRIEF DESCRIPTION OF THE DRAWINGS

FIG. 1 shows schematically the simplest assembly of a material for optical applications according to the invention including a flexible support 1; a multilayer comprising a porous or nanoporous layer 2 containing inorganic nanoparticles; and on top of this layer, a non-porous polymer layer 4; 3 indicates the boundary layer between the porous or nanoporous layer 2 and the non-porous polymer layer 4.

FIG. 2 shows schematically another material for optical applications according to the invention including the two multilayer systems of FIG. 1 which are inversely combined; a flexible support 1; 2 and 2′ are each a porous or nanoporous layer containing optionally different inorganic nanoparticles; 4 and 4′ are optionally different non-porous polymer layers; and 3 and 3′ indicate the boundary layers between the porous or nanoporous layers 2 and 2′ and the non-porous polymer layers 4 and 4′.

### DETAILED DESCRIPTION OF THE INVENTION

In general the invention provides flexible materials for optical applications, composed of a flexible support and at least two layers in direct contact, having a big difference of their refractive indices, on said support. These materials have a high mechanical flexibility and may be manufactured in a cost-efficient manner in high quantities. Various combinations of porous or nanoporous layers containing inorganic nanoparticles and having a low refractive index, with non-porous polymer layers having a high refractive index are included in the invention.

More specifically, the invention provides flexible materials for optical applications in a wavelength range of λ₁ to λ₂, λ₁ being smaller than λ₂, composed of a flexible support and at least one multilayer that comprises a porous or nanoporous layer having a low refractive index and contains inorganic nanoparticles and at least one binder, and a non-porous polymer layer having a high refractive index and which is in direct contact with the porous or nanoporous layer, wherein the maximum thicknesses of the boundary layers, in which the refractive index changes from one value to the other and which are located between the porous or nanoporous layers and the non-porous polymer layers that are in direct contact, amount to maximally 0.2 times wavelength λ₂

The difference of the refractive indices of the two layers in the range λ₁ to λ₂ of interesting wavelengths is at least 0.20. Higher values, preferably between 0.20 and 0.76, in the range λ₁ to λ₂ of interesting wavelengths, are preferred. Furthermore, it is always assumed that λ₁ is smaller than λ₂.

There is always a boundary layer between the two layers, wherein the refractive index changes from one value to the other. The thickness of this boundary layer is very important for optical applications and greatly influences the percentage of the light that is reflected. The wavelength of the light is crucial. A boundary layer is optically sharp in the case where the thickness of the boundary layer in the range of interesting wavelengths λ₁ to λ₂ is not bigger than ⅕ of the light wavelength.

The materials for optical applications are used in the wavelength range from 200 nm (λ₁) to 2500 nm (λ₂).

The visible part of the spectrum of light at wavelengths from 400 nm to 700 nm is interesting for example for all applications where optical effects that should be visible by the human eye are desired. This could be, for example, the creation of physical colors for decorative purposes, for color effects in safety features or for simple optical sensors based on a color change of a test strip. The range of interesting wavelengths λ₁ to λ₂ for the materials according to the invention covers the complete visible spectral range from 400 nm to 700 nm. In this range, optically sharp boundary layers must have a thickness of not more than 140 nm. A thickness of the boundary layer of not more than 70 nm is preferred.

In applications where ultraviolet radiation is used, for example in safety features that should be visible only under UV light, the range of interesting wavelengths λ₁ to λ₂ for the materials according to the invention is from 200 nm to 400 nm. Optically sharp boundary layers for this application must have a thickness of not more than 80 nm. A thickness of the boundary layer of not more than 40 nm is preferred.

In applications where infrared radiation is used, for example in safety features that are visible only by infrared sensors or infrared detectors, the range of interesting wavelengths λ₁ to λ₂ for the materials according to the invention is from 700 nm to 2500 nm. Optically sharp boundary layers for this application must have a thickness of not more than 500 nm. A thickness of the boundary layer of not more than 250 nm is preferred.

A multilayer comprising a porous or nanoporous layer having a low refractive index and, in direct contact, a non-porous layer having a high retraction index, is the smallest basic unit of the materials according to the invention. The materials according to the invention comprise at least one such multilayer or a multitude of such multilayers, wherein the differences of refractive indices of the different layers, the sequence of the layers, the orientation of the layers, the composition of the layers and their thickness depend on the field of application.

The porous or nanoporous layer of the material according to the invention having the low refractive index and containing inorganic nanoparticles, has a dry thickness from 0.2 μm to 60.0 μm, preferably from 1.0 μm to 40.0 μm, more preferably from 2.0 μm to 20.0 μm.

The non-porous polymer layer of the material according to the invention having the high refractive index has a dry thickness from 0.2 μm to 2.5 μm, preferably from 0.2 μm to 2.0 μm, more preferably from 0.3 μm to 0.8 μm.

The materials according to the invention may comprise, optionally, one or more supplementary layers with other functionalities (for example luminescence layers, electrically conductive layers, reflecting layers, protective layers, layers for mechanical stabilization or stripping layers) between the multilayers (if there is more than one multilayer), between the support and the multilayer or on top of the multilayers.

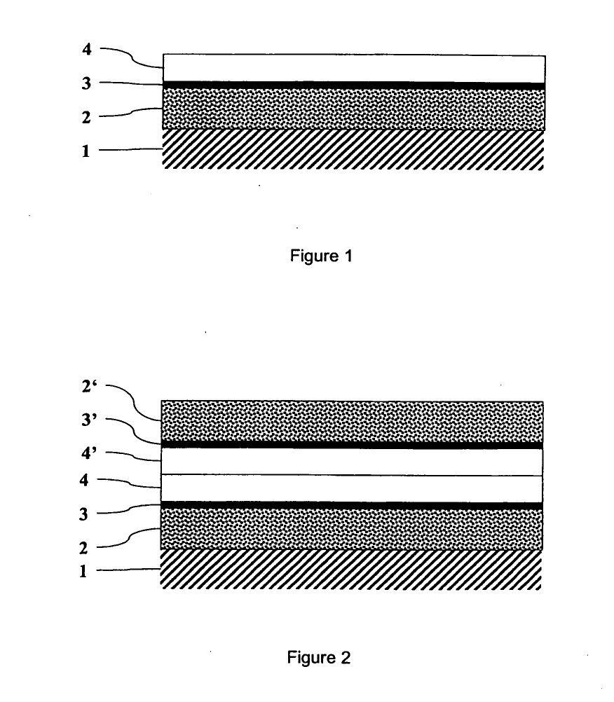

In a preferred embodiment of the invention, the material according to the invention, as shown in FIG. 1, is composed of a flexible support and at least one porous or nanoporous layer containing inorganic nanoparticles and having a low refractive index and, on top of it, a non-porous polymer layer having a high refractive index. This embodiment is interesting for applications, where the light propagating in the polymer layer with high refractive index should be decoupled from the flexible support independently of the fact that the light has been coupled into the non-porous polymer layer having the high refractive index or has been generated in this layer. An example of such an application is described by T. Tsutsui, M. Yahiro, H. Yokogawa, K. Kawano and M. Yokoyama in “Doubling Coupling-Out Efficiency in Organic Light-Emitting Devices Using a Thin Silica Aerogel Layer”, Advanced Materials 13, 1149-1152 (2001), where the coupling-out efficiency of light in organic light-emitting diodes was investigated.

In a further preferred embodiment of the invention, the material according to the invention, as shown in FIG. 2, has a second multilayer comprising a porous or nanoporous layer containing inorganic nanoparticles and having a low refractive index and a non-porous polymer layer having a high refractive index in inverted order, on top of the first multilayer comprising a porous or nanoporous layer containing inorganic nanoparticles and having a low refractive index and a non-porous polymer layer having a high refractive index. This embodiment is interesting for applications, where the influence of the surroundings on the optical properties of the polymer layer with high refractive index should be controlled in a specific way. Such an application, wherein the non-porous polymer layer having the high refractive index is functioning as a light waveguide and the porous or nanoporous layers containing inorganic nanoparticles and having the low refractive index is shielding the waveguide on both sides of the cladding of the waveguide. There is no supplementary optical boundary layer in the case where the refractive indices of the two non-porous layers (4) and (4′) are identical. In this way it is possible, for instance, to produce several independent waveguides, each consisting of a core layer and two claddings, or to influence selectively the communication between these waveguides. The cladding of waveguide allows, for instance, that the flexible material according to the invention is glued or transferred onto another support without influencing the properties of the non-porous polymer layer having the high refractive index.

As the layer containing the inorganic nanoparticles and having the low refractive index is porous or nanoporous, compounds with a diameter lower than the mean pore diameter may penetrate into the pores of the porous or nanoporous layer and influence selectively, for example, the behavior of a waveguide. This principle is well known in the field of application of waveguides in sensor technology and optical communications engineering. It is described for example by W. Bludau in the book “Lichtwellenleiter in Sensorik and optischer Nachrichtentechnik”, pages 191-198 and 215-227, Springer Editions 1998, ISBN 3-540-63848-2 or by P. J. Skrdla, S. B. Mendes, N. R. Armstrong and S. S. Saavedra in “Planar Integrated Optical Waveguide Sensor for Isopropyl Alcohol in Aqueous Media”, Journal of Sol-Gel Science and Technology, 24, 167-173 (2002).

The porous or nanoporous layers having a low refractive index contain inorganic nanoparticles and, optionally, a small amount of binder and other ingredients. They have, after drying, a defined, measurable pore volume. The pore volume may be determined by the use of the BET method. The BET method for the determination of the pore volume has been described by S. Brunauer, P. H. Emmet and I. Teller in “Adsorption of Gases in Multimolecular Layers”, Journal of the American Chemical Society 60, 309-319 (1938).

In a simpler method, the pores are filled with a suitable solvent of known density and the pore volume is determined by the weight increase of the layer. The pore volume determined in this way for the porous or nanoporous layers according to the invention is from 0.1 ml/g to 2.5 ml/g, wherein the reference is the unit weight of the porous or nanoporous layer containing inorganic nanoparticles.

Preferred pore volumes determined in this way for the materials according to the invention are from 0.2 ml/g to 2.5 ml/g, particularly preferred are pore volumes from 0.4 ml/g to 2.5 ml/g.

The refractive index of the porous or nanoporous layer containing the inorganic nanoparticles is influenced by the porosity. An increase in porosity lowers the refractive index. Theoretically, all values of refractive indices between 1.00 (air) and the refractive index of the used inorganic nanoparticles may be attained, for example the value 1.45 when using SiO₂ as inorganic nanoparticle. All relevant values of refractive indices used in practice from 1.05 to 1.40 may be adjusted in this way.

The effective value of the refractive index may be calculated approximately by computing the volume-averaged sum of the value of the refractive index of the nanoparticle network and the value of the gas-filled pores.

A porous or nanoporous layer having a porosity of 0.80 consisting mainly of SiO₂ nanoparticles having a refractive index of 1.45 and air having a refractive index of 1.00 has, for example, has an effective refractive index of 1.09.

After applying the coating solution of the porous or nanoporous layer containing inorganic nanoparticles and having the low refractive index, a three-dimensional network of these nanoparticles is slowly formed during drying. The interstices of this network are filled by the used solvent, respectively dispersing agent, and other optionally used ingredients. Later in the drying step, the used solvent, respectively the dispersing agent, is removed. If sufficiently small amounts of ingredients, for example binders, are used, the remaining ingredients are not able to fill completely the interstices between the nanoparticles. Therefore, gas-filled pores are created in the nanoparticle network. This three-dimensional network consisting of two phases, a solid one and a gaseous one, has structures of sub-micrometer size. By a careful control of the size of these structures scattering effects and, therefore the transparency of the layers according to the invention may be influenced. These effects may be characterized, for example, for layers on a transparent polymer support, by the optical transmission at a wavelength of 550 nm.

In a preferred embodiment of the invention, the porous or nanoporous layer has a transparency value for light of wavelength 550 nm from 60% to 99%. In a more preferred embodiment of the invention, the nanoporous layer has a transparency value for light of wavelength 550 nm from 80% to 95%. In the most preferred embodiment of the invention, the nanoporous layer has a transparency value for light of wavelength 550 nm from 85% to 95%.

The materials according to the invention solve the problems of brittleness and stiffness of the porous or nanoporous layers for optical applications described in the state of the art. The desired mechanical properties are attained by the addition of a suitable binder into the porous or nanoporous layers containing inorganic nanoparticles.

Natural, precipitated or fumed metal oxides, metal oxide/hydroxides and natural or synthetic zeolites may be used as inorganic nanoparticles for the preparation of porous or nanoporous layers having a low refractive index. SiO₂, Al₂O₃, TiO₂, ZnO, ZrO₂ and SnO₂ or the mixed oxide of indium and tin may be used as metal oxides. It is also possible to use mixtures of all of these compounds. AlOOH may be used, for example, as metal oxide/hydroxide.

Preferred inorganic nanoparticles have a refractive index below 1.80 at a wavelength of 550 nm. Particularly preferred inorganic nanoparticles are precipitated or fumed aluminium oxide, aluminium oxide/hydroxide and the zeolites beta, ZSM-5, mordenite, LTA (Linde type A), faujasite and LTL (Linde type L).

Official structure names of the zeolites mentioned before are listed for example in the book by C. Bärlocher, W. M. Meier and D. H. Olson, “Atlas of Zeolite Framework Types”, Fifth edition, Elsevier (2001), ISBN 0-444-50701-9.

The size of the inorganic nanoparticles (primary particles) may be determined by image display methods such as high-resolution transmission electron microscopy or scanning electron microscopy.

The mean particle diameter of the inorganic nanoparticles (primary particles) is preferably from 5 nm to 200 nm. Particularly preferred is the size range from 10 nm to 60 nm. The inorganic nanoparticles preferably have a narrow particle size distribution, wherein at least 90% of the primary particles have a diameter that is smaller than the double mean diameter mentioned before and where there are practically no primary particles having a bigger diameter than the triple mean particle diameter mentioned before.

The inorganic nanoparticles may also be present as agglomerates (secondary particles), where the solid has a measurable BET pore volume.

Two different types of the particularly preferred silicium dioxide may be used, the first one prepared by precipitation in a wet process (precipitated silicium dioxide) and the second one prepared in a gas phase reaction (fumed silicium dioxide).

Precipitated silicium dioxide may be prepared for example in the wet process by metathesis of sodium silicate with an acid or by passing through a layer of ion-exchange resin as silicium dioxide sol, by heating and maturing of this silicium dioxide sol or by gelling of a silicium dioxide sol.

Fumed silicium dioxide is generally prepared by flame pyrolysis, for example by burning silicon tetrachloride in the presence of hydrogen and oxygen. An example of such a fumed silicium dioxides is Aerosil® 200 (SiO₂ having its isoelectric point at a value of pH of 2.0), available from DEGUSSA AG, Frankfurt/Main, Germany. This substance has, according to its data sheet, a specific BET surface area of about 200 m²/g and a size of the primary particles of about 12 nm. A further example is Cab-O-Sil® M-5, available from Cabot Corporation, Billerica, USA. This substance has, according to its data sheet, a specific BET surface area of about 200 m²/g and a size of the primary particles of about 12 nm. The agglomerates have a length between 0.2 μm and 0.3 μm.

Fumed silicium dioxide having an average size of the primary particles of at most 20 nm and a specific BET surface area of at least 150 m²/g is preferred in this invention.

The preferred zeolite beta is available in the form of nanoparticles of a mean size of 30 nm from NanoScape AG, Munich, Germany. The other nanocrystalline zeolites (the mean size of the primary particles is indicated in brackets) ZSM-5 (70 nm-100 nm), mordenite (500 nm), LTA (90 nm), faujasite (80 nm) and LTL (50 nm) are also available from them same source.

Aluminum oxide/hydroxide may be used, for example, as metal oxide/hydroxide. Particularly preferred is pseudo-boehmite.

The aluminum oxide/hydroxides are preferably prepared in a sol-gel process in the complete absence of acids, as described for example in patent DE 3,823,895.

A preferred aluminum oxide is γ-aluminum oxide.

In a particularly preferred embodiment of the invention, the aluminum oxides and the aluminum oxide/hydroxides contain elements of the rare earth metal series in their crystal lattice. Their preparation is described for example in patent application EP 0,875,394. Such aluminum oxides or aluminum oxide/hydroxides contain one or more elements of the rare earth metal series of the periodic system of the elements with atomic numbers 57 to 71, preferably in a quantity from 0.4 to 2.5 mole percent relative to Al₂O₃. A preferred element of the rare earth metal series is lanthanum.

The surface of the inorganic nanoparticles may be modified in order to break up agglomerates of the primary particles that could be present, into smaller units and to stabilize them. The size of the dispersed particles has a considerable influence on the transparency of the porous or nanoporous layer containing these nanoparticles. The surface modification may also improve the compatibility of the nanoparticle surface with the used binders or the dispersing agent. Such a modification may result in an uncharged, a positively charged or a negatively charged surface.

A preferred method for the surface modification of silicium dioxide, in order to obtain a positively charged surface, is the treatment with polyaluminium hydroxychloride, as described for example in patent application DE 10,020,346. The surface modification of fumed silicium dioxide with aluminum chlorohydrate is described in patent application WO 00/20,221.

Another preferred method of surface modification of silicium dioxide is the treatment with aminoorganosilanes, as described for example in patent application EP 0,663,620.

A particularly preferred method of surface modification of silicium dioxide is described in patent application EP 1,655,348, wherein the surface of silicium dioxide is treated with the reaction products of at least one aminoorganosilane and a compound of trivalent aluminum.

Preferred compounds of trivalent aluminum for the surface modification with the reaction products of at least one aminoorganosilane and a compound of trivalent aluminum are aluminum chloride, aluminum nitrate, aluminum acetate, aluminum formiate and aluminum chlorohydrate.

The amount of the compound of trivalent aluminum typically is between 0.1 percent by weight and 20 percent by weight relative to the amount of silicium dioxide. A value between 0.5 percent by weight and 10 percent by weight is preferred.

Particularly preferred aminoorganosilanes for the surface modification with the reaction products of at least one aminoorganosilane and a compound of trivalent aluminum are 3-aminopropyltrimethoxysilane, N-(2-aminoethyl)-3-amino-propyltrimethoxysilane, (3-triethoxysilylpropyl)-diethylentriamine, 3-minopropyltriethoxysilane, N-(2-aminoethyl)-3-amino-propyltriethoxysilane, (3-triethoxysilylpropyl)diethylenetriamine and their mixtures.

The total amount of the aminoorganosilane, respectively the mixture of aminoorganosilanes, typically is from 0.1 percent by weight to 10 percent by weight relative to the amount of silicium dioxide. A value from 0.5 percent by weight to 20 percent by weight is preferred.

The weight ratio between the compound of trivalent aluminum (such as aluminum chlorohydrate) and the aminoorganosilane is preferably chosen in such a way that the desired value of pH is attained when the two compounds are mixed. A molar ratio from 0.1 to 2.0 is preferred. Particularly preferred is a molar ratio from 0.5 to 1.5, taking into account the number of aluminium atoms and the number of amino groups of the aminoorganosilane.

Fumed silicium dioxide having a size of the primary particles of not more than 20 nm is particularly preferred for the surface modification with the reaction products of a compound of trivalent aluminum (such as aluminum chlorohydrate) and at least one aminoorganosilane.

Fumed silicium dioxide is particularly preferred for the surface modification with the reaction products of a compound of trivalent aluminum (such as aluminum chlorohydrate) and at least one aminoorganosilane.

Dispersion at high shear rates gives an equal distribution of the reaction products on the surface of the silicium dioxide. Furthermore, the rheological behavior of the dispersion is improved.

The porous or nanoporous layers having containing inorganic nanoparticles and having the low refractive index contain the inorganic nanoparticles in an amount from 0.2 g/m² to 60.0 g/m², preferably from 1.0 g/m² to 40.0 g/m², most preferably from 2.0 g/m² to 20.0 g/m².

The amount of binder in the porous or nanoporous layer should be sufficiently low in order to attain the desired porosity, but also sufficiently high in order to obtain mechanically stable, non-brittle coatings adhering well to the flexible support. Amounts up to 60 percent by weight relative to the amount of the inorganic nanoparticles may be used. Preferred are amounts from 0.5 percent by weight to 40.0 percent by weight relative to the amount of the inorganic nanoparticles in the porous or nanoporous layer having the low refractive index. Particularly preferred are amounts from 10.0 percent by weight to 30.0 percent by weight relative to the amount of the inorganic nanoparticles in the porous or nanoporous layer having the low refractive index.

Suitable binders for the porous or nanoporous layer containing inorganic nanoparticles and having the low refractive index are in general water-soluble hydrophilic polymers.

Synthetic, natural or modified natural polymers such as completely or partially hydrolyzed polyvinyl alcohol or copolymers of vinyl acetate and other monomers; modified polyvinyl alcohols; polyethylene oxides; homopolymers or copolymers of (meth)acrylamide; polyvinyl pyrrolidones; polyvinyl acetals; polyurethanes as well as starch, cellulose or modified cellulose such as hydroxyethyl cellulose, carboxymethyl cellulose and gelatin may be used. All these polymers may also be used as mixtures.

Polythiophene, polyanilines, polyacetylenes poly(3,4-ethylene)dioxythiophene, mixtures of poly(3,4-ethylene)dioxythiophene-poly(styrene sulphonate), polyfluorene, polyphenylene and polyphenylenevinylene in its double strand modification as well as block copolymers of different conductive and non-conductive polymers may also be used as conductive binders. Poly(3,4-ethylene)dioxythiophene is preferred.

Particularly preferred synthetic binders for the porous or nanoporous layer containing inorganic nanoparticles and having the low refractive index are modified or non-modified polyvinyl alcohol, polyvinyl pyrrolidone or mixtures thereof.

The polymers mentioned above having groups with the possibility to react with a cross-linking agent may be cross-linked or hardened to form essentially water insoluble layers. Such cross-linking bonds may be either covalent or ionic. Cross-linking or hardening of the layers allows for the modification of the physical properties of the layers, like for instance their liquid absorption capacity, their dimensional stability under exposure to liquids, vapors or temperature changes, or their resistance against layer damage and brittleness.

The cross-linking agents or hardeners are selected depending on the type of the water-soluble polymers to be cross-linked.

Organic cross-linking agents and hardeners include for example aldehydes (such as formaldehyde, glyoxal or glutaraldehyde), N-methylol compounds (such as dimethylol urea or methylol dimethylhydantoin), dioxanes (such as 2,3-dihydroxydioxane), reactive vinyl compounds (such as 1,3,5-trisacrylolyl hexahydro-s-triazine or bis-(vinylsulfonyl)ethyl ether), reactive halogen compounds (such as 2,4-dichloro-6-hydroxy-s-triazine); epoxides; aziridines; carbamoyl pyridinium compounds or mixtures of two or more of the above-mentioned cross-linking agents.

Inorganic cross-linking agents or hardeners include for example chromium alum, aluminum alum, boric acid, zirconium compounds or titanocenes.

The layers may also contain reactive substances that cross-link the layers under the influence of ultraviolet light, electron beams, X-rays or heat.

These polymers may be blended with water insoluble natural or synthetic high molecular weight compounds, particularly with acrylate latices or with styrene acrylate latices.

In another embodiment of the invention, the nanoporous layers having the low refractive index further may contain compounds absorbing light in the interesting wavelength range from 200 nm to 2500 nm. These are organic compounds absorbing light in the wavelength range from 200 nm to 700 nm in a preferred embodiment of the invention.

In another embodiment of the invention, the nanoporous layers having the low refractive index further may contain luminescent organic molecules, luminescent organic pigments, luminescent organic polymers, luminescent inorganic nanoparticles as well as organic or inorganic nanoparticles containing luminescent compounds in their interior, emitting light in the interesting wavelength range from 200 nm to 2500 nm.

The non-porous polymer layer having the high refractive index consists of synthetic, natural or modified natural water-soluble polymers such as completely or partially hydrolyzed polyvinyl alcohol or copolymers of vinyl acetate and other monomers; modified polyvinyl alcohols; (meth)acrylated polybutadiene; homopolymers or copolymers of (meth)acrylamide; polyvinyl pyrrolidones; polyvinyl acetals; polyurethanes as well as starch or modified starch, cellulose or modified cellulose such as hydroxyethyl cellulose, carboxymethyl cellulose and gelatin or their mixtures.

Preferred synthetic polymers are modified polyvinyl alcohol; polyurethane (meth)-acrylated polybutadiene, copolymers of (meth)acrylamide and poly(acrylnitriles) or their mixtures.

Conductive polymers such as polythiophene, polyanilines, polyacetylenes poly(3,4-ethylene)dioxythiophene, mixtures of poly(3,4-ethylene)dioxythiophene-poly(styrene sulphonate), polyfluorene, polyphenylene and polyphenylenevinylene in the double strand modification as well as block copolymers of different conductive polymers and block copolymers of conductive and non-conductive polymers may also be used as conductive binders. Poly(3,4-ethylene)dioxythiophene is preferred.

Polyelectrolytes such as salts of polystyrene sulphonic acid, salts of polyvinyl sulfonic acid, salts of the poly-4-vinylbenzyl ammonium cation, salts of polyallylamine, salts of poly(ethyleneimine), salts of the poly(dimethyldiallyl) cation, poly(allylamine) hydrochloride, chitosan, polyacrylic acids and their salts, dextrane sulfate, alginates, salts of poly(1-[4-(3-carboxyl-4-hydroxyphenylazo)benzene sulfonamido]-1,2-ethane, salts of the poly(dimethyldiallylammonium) cation, block copolymers as well as their mixtures may also be used.

This layer may also be cross-linked or hardened, as described above for the layer having the low refractive index.

In another embodiment of the invention, the non-porous polymer layer having the high refractive index may also consist of water dispersible thermoplastic polymers. In this case the polymer film is formed, if necessary, in a supplementary step, after the application of the layer, by a heat treatment under pressure. This supplementary heat treatment under pressure is not necessary, for example, in the case where the layer reaches or exceeds the glass transition temperature of the thermoplastic polymer for a certain time during the drying process.

The water dispersible thermoplastic polymers are, for example, particles, latices or waxes of polyethylene, polypropylene, polytetrafluoroethylene, polyamides, polyesters, polyurethanes, acrylnitriles, polymethacrylates such as methylmethacrylate, polyacrylates, polystyrenes, polyvinyl chloride, polyethylene terephthalate, copolymers of ethylene and acrylic acid and paraffin waxes (such as Polysperse, available from Lawter Int., Belgium). Mixtures of these compounds or polymers such as polystyrene and acrylates, copolymers of ethylene and acrylates may also be used. The particle size of the latices is from 20 nm to 5000 nm. Sizes from 40 nm to 1000 nm are preferred. Particularly preferred are sizes from 50 nm to 500 nm. The glass transition temperature is from 30° C. to 170° C., preferably from 50° C. to 110° C., most preferably from 60° C. to 90° C.

In the case where the layer containing the latex particles does not already form a film during manufacturing, the latex particles may be melted to form a film using devices known to someone skilled in the art under conditions as used during lamination of photographic or ink jet printing paper. The laminator GBC 3500 Pro, available from GBC European Films Group, Kerkrade, Holland, may be used, for example. This device is particularly suitable for a heating treatment at a temperature of 120° C. at a throughput speed of about 27 cm/min.

The water dispersible thermoplastic polymers may also be built up from several shells, wherein, for example, the core and an outer shell have different capability of swelling or a different glass transition temperature.

The polymer particles or polymer latices may have an uncharged surface or have a positive or a negative surface charge.

The polymer particles may be mixed with water-soluble binders, for example the binders mentioned before, preferably with polyvinyl alcohol or mixtures of different polyvinyl alcohols. Preferred are polyvinyl alcohols having a viscosity of at least 26 mPasec and a degree of hydrolysis of at least 70%.

In another embodiment of the invention, polymer particles that may be cross-linked by ultraviolet radiation may be used. These polymer particles are dispersed in water and applied to the porous or nanoporous layer containing inorganic nanoparticles and having the low refractive index. Afterwards, the non-porous polymer layer is formed by a heating treatment under pressure and/or by irradiation with ultraviolet radiation, as described by M. M. G. Antonisse, P. H. Binda and S. Udding-Louwrier in “Application of UV-curable powder coatings on paperlike substrates”, American Ink Maker 79(5), 22-26 (2001).

In another embodiment of the invention, the non-porous polymer layer having the high refractive index may contain in addition to the binders non-porous inorganic compounds that may further increase the refractive index. Inorganic compounds having a higher refractive index in the interesting wavelength range from 200 nm to 2500 nm than the used polymer in the non-porous polymer layer are used for this purpose. The refractive index of the non-porous layer is increased by the addition of the inorganic compound. In contrast to the porous or nanoporous layers containing inorganic compounds and having the low refractive index, the percentage of inorganic compounds relative to the used polymer is kept so low that no porosity is resulting, because the presence of gas-filled pores would reduce the refractive index. A layer is “non-porous” in the case where the ratio of the pore volume to the total volume is below 4%. The effectively achievable refractive indices of the resulting non-porous layer is always between the refractive index of the non-porous layer without the inorganic compound and the refractive index of the inorganic compound.

In a preferred embodiment of the invention, the mean particle diameter of these inorganic nanoparticles (primary particles) is preferably from 5 nm to 200 nm. Particularly preferred is the size range from 10 to 60 nm. The inorganic nanoparticles preferably have a narrow size distribution, where at least 90% of the primary particles have a diameter that is smaller than the double mean diameter mentioned before and where there are practically no primary particles having a bigger diameter than the triple mean particle diameter mentioned before.

Examples of such preferred nanoparticles in the non-porous polymer layer are PbS, TiO₂, SiO₂, Al₂O₃, ZrO₂, ZnO and SnO₂.

In another embodiment of the invention, the inorganic compounds are polymers such as for example poly(dibutyltitanate).

In another embodiment of the invention, the non-porous polymer layers having the high refractive index may contain in addition to the polymers compounds that absorb light in the interesting wavelength range from 200 nm to 2500 nm. These are organic compounds absorbing light in the wavelength range from 200 nm to 700 nm.

In another embodiment of the invention, the non-porous polymer layer having the high refractive index further may contain luminescent organic molecules, luminescent organic pigments, luminescent organic polymers, luminescent inorganic nanoparticles as well as organic or inorganic nanoparticles containing luminescent compounds in their interior, emitting light in the interesting wavelength range from 200 nm to 2500 nm.

A wide variety of flexible supports may be used for the manufacture of the materials according to the invention. All the supports used in the photographic industry may be used. For the manufacture of the materials according to the invention all supports that are used in the manufacture of photographic materials, such as transparent films made from cellulose esters such as cellulose triacetate, cellulose acetate, cellulose propionate or cellulose acetate/butyrate, polyesters such as polyethylene terephthalate or polyethylene naphthalate, polyamides, polycarbonates, polyimides, polyolefins, polyvinyl acetals, polyethers, polyvinyl chloride and polyvinyl sulphones. Polyester film supports, and especially polyethylene terephthalate such as for instance Cronar® manufactured by Du-Pont Tejin Films or polyethylene naphthalate are preferred because of their excellent dimensional stability characteristics.

The usual opaque supports used in the manufacture of photographic materials may be used including for example baryta paper, polyolefin coated papers, voided polyester as for instance Melinex® manufactured by Du-Pont Tejin Films. Particularly preferred are polyolefin-coated papers or voided polyester.

Supports consisting of acrylnitrile, butadiene and styrene, polycarbonates, polyetherimide, polyester ketones, poly(methylmethacrylate), polyoxymethylene and polystyrene may be used as well.

When such supports, in particular polyester, are used, a subbing layer is advantageously coated first to improve the bonding of the layers to the support. Useful subbing layers for this purpose are well known in the photographic industry and include for example terpolymers of vinylidene chloride, acrylonitrile and acrylic acid or of vinylidene chloride, methyl acrylate and itaconic acid. In place of the use of a subbing layer, the surface of the support may be subjected to a corona-discharge or corona/aerosol treatment before the coating process.

All these flexible supports may have an electrically conductive layer at their surface. Plastic supports or plastic supports having a metal layer or a layer of indium tin oxide on their surface are preferred.

Flexible metal foils, such as foils made from aluminum, may also be used.

All these supports may also have three-dimensional structures at their surface.

The layers according to the invention are in general applied to the flexible support from aqueous solutions or dispersions containing all necessary ingredients. In many cases, wetting agents are added to those coating solutions in order to improve the coating behavior and the evenness of the layers. Although these surface active compounds are not specifically claimed in this invention, they nevertheless form an important part of the invention.

In order to prevent the brittleness of the layers containing inorganic nanoparticles and having the low refractive index plasticizers such as for instance glycerol may be added.

The materials according to the invention have at least one multilayer comprising a porous or nanoporous layer having a low refractive index and a non-porous polymer layer having a high refractive index, or several such multilayers, wherein the difference of refractive indices of the different layers, the sequence of the layers, the orientation of the layers, the composition of the layers and their thickness depend on the use of these materials. In the case of several multilayers, they may be applied one after the other or simultaneously to the flexible support.

In a first embodiment of the invention for the preparation of such a flexible material for optical applications, the porous or nanoporous layer containing inorganic nanoparticles and a binder, and, optionally, other ingredients, is applied first to the flexible support. Aqueous, colloidal dispersions of these inorganic nanoparticles and the binder and, optionally, other ingredients, are applied at temperatures from 0° C. to 100° C., preferably from 15° C. to 60° C., to flexible metal, paper or plastic supports that may also have a coating of indium tin oxide or metals. The coated flexible support is dried afterwards. The non-porous polymer layer having the high refractive index is applied to the coated flexible support in a second step, by applying aqueous solutions of the polymer, that may optionally also comprise other ingredients, or in the case where water dispersible thermoplastic polymers are used, by applying colloidal dispersions of these thermoplastic polymers, optionally together with a supplementary binder, at temperatures from 0° C. to 100° C., preferably from 15° C. to 60° C. The coated flexible support is dried afterwards.

In a second embodiment of the invention for the preparation of such a flexible material for optical applications, the non-porous polymer layer having the high refractive index is first applied to the flexible support. Afterwards, the porous or nanoporous layer containing inorganic nanoparticles and a binder, and, optionally, other ingredients, is applied to the coated flexible support.

In another embodiment of the invention, other multilayers may be applied to the flexible support already coated with one multilayer, by using one of the methods described before. In the first multilayer, either the non-porous polymer layer having the high refractive index or the porous or nanoporous layer having the low refractive index may be in direct contact with the support.

In a preferred embodiment of the invention, two multilayers are applied to the flexible support, wherein the sequence of the layers may be as follows: flexible support, a porous or nanoporous layer having a low refractive index, a non-porous layer having a high refractive index, then a second non-porous layer having a high refractive index, and on top of it a second porous or nanoporous layer having a low refractive index.

In another embodiment of the invention, other multilayers comprising each a porous or nanoporous layer containing inorganic nanoparticles and having a low refractive index and a non-porous layer having a high refractive index, are applied simultaneously in one step to flexible metal, paper or plastic supports that may also have a coating of indium tin oxide or metals. The flexible support coated in this way is dried afterwards.

In a particularly preferred embodiment of the invention, the multilayers comprising each a porous or nanoporous layer containing inorganic nanoparticles and having a low refractive index and a non-porous layer having a high refractive index, are applied in two separate coating steps to the flexible support.

Drying may be done with air, with infrared radiation, with microwave radiation, by contact drying (the drying energy is transmitted to the material by heat conduction from the heated surface of a medium) or by a combination of these methods.

Drying is preferably done in a gas mixture, preferably air, with the condition that the temperature of the layer does not exceed 100° C. during drying, preferably 60° C.

The coating solutions may be applied to the flexible support by different methods. The coating methods include all well known coating methods, as for example gravure coating, roll coating, rod coating, slit coating, extrusion coating, doctor blade coating, cascade coating, curtain coating and other common coating methods. In the case where the flexible support is fixed to a solid surface, immersion coating or spin coating may also be used.

The coating speed depends on the used coating method and may be varied within wide limits. Curtain coating at speeds from 30 m/min to 2000 m/min, preferably from 50 m/min to 500 m/min, is the preferred coating method for the manufacture of the materials according to the invention.

All multilayers mentioned before may contain optionally, in one or more layers, other ingredients as for instance luminescent or light absorbing compounds.

All multilayers mentioned before may optionally contain, in the non-porous polymer layer having the high refractive index, inorganic compounds in order to increase the refractive index.

In a further embodiment of the invention, one or more supplementary layers having other functionalities (for example luminescence layers, electrically conductive layers, reflecting layers, protective layers, layers for mechanical stabilization or stripping layers) may be present between the multilayers (if there is more than one), between the multilayers and the support or on top of the multi-layers.

It is also possible to introduce structures into the applied layers, either at the end of coating or in an intermediate step in the case of multiple coating. Such a structure may be created by ink jet printing, photolithography, offset printing, laser marking or embossing.

The present invention will be illustrated in more detail by the following examples without limiting the scope of the invention in any way.

### EXAMPLES

### Example 1

A porous or nanoporous layer having a low refractive index and having the composition (in the dry state) as listed in Table 2 was applied to a subbed transparent polyester film Cronar® 742, available from DuPont Teijin Films, Luxemburg.

TABLE 2

| Ingredient | Quantity (g/m²) |
|---|---|
| Surface modified SiO₂ | 6.000 |
| Polyvinyl alcohol C | 1.300 |
| Cross-linking agent | 0.229 |

The surface modified SiO₂ was prepared according to the method of example 1 of patent application EP 1,655,348.

Polyvinyl alcohol C is available as Mowiol 40-88 from Omya AG, Oftringen, Switzerland. The cross-linking agent is boric acid, available from Schweizerhall Chemie AG, Basel, Switzerland.

A non-porous layer with a thickness of about 0.24 μm having a high refractive index and consisting of polyvinyl alcohol B was applied onto this porous or nanoporous layer having a low refractive index.

Polyvinyl alcohol B is available as Mowiol 56-98 from Omya AG, Oftringen, Switzerland.

### Example 2

A porous or nanoporous layer having a low refractive index and having the composition (in the dry state) as listed in Table 3 was applied to the subbed transparent polyester film of Example 1.

TABLE 3

| Ingredient | Quantity (g/m²) |
|---|---|
| Surface modified SiO₂ | 21.052 |
| Polyvinyl alcohol C | 4.928 |
| Cross-linking agent | 0.800 |

A non-porous layer having a high refractive index and having the composition (in the dry state) as listed in Table 4 was applied onto this porous or nanoporous layer having a low refractive index.

TABLE 4

| Ingredient | Quantity (g/m²) |
|---|---|
| Polyvinyl alcohol D | 0.070 |
| Latex | 0.930 |

Polyvinyl alcohol D is available as Gohsefimer K-210 from Nippon Synthetic Chemical Industry Ltd., Osaka, Japan. The latex is Jonrez E2001, available from MeadWestvaco Corporation, Stamford, USA.

This layer was sealed at a temperature of 120° C. at a speed of about 27 cm/min with a laminator GBC 3500.

### Example 3

A porous or nanoporous layer having a low refractive index and having the composition (in the dry state) as listed in Table 5 was applied to the subbed transparent polyester film of Example 1.

TABLE 5

| Ingredient | Quantity (g/m²) |
|---|---|
| Aluminium oxide/hydroxide containing | 20.250 |
| lanthanum | |
| Lactic acid | 0.369 |
| Polyvinyl alcohol A | 0.785 |
| Polyvinyl alcohol B | 1.830 |
| Cross-linking agent | 0.021 |

The aluminum oxide/hydroxide was prepared according to the method of Example 1 of patent application EP 0,967,086.

A non-porous layer having a high refractive index and having the composition (in the dry state) as listed in Table 6 was applied onto this porous or nanoporous layer having a low refractive index.

TABLE 6

| Ingredient | Quantity (g/m²) |
|---|---|
| Polyvinyl pyrrolidone | 0.500 |
| Cross-linking agent | 0.250 |

Polyvinyl pyrrolidone is available as Luviskol K90 from BASF AG, Wädenswil, Switzerland.

### Test Methods

The flexible material for optical applications according to the invention show well visible interference colors when regarded in daylight. These interference colors are produced by multiple reflections of incident light at the boundary layer between the porous or nanoporous layer containing inorganic nanoparticles and having the low refractive index and the non-porous polymer layer having the high refractive index. They are only well visible in the case where the boundary layer is sharp enough optically and where the difference of the refractive indices of the layers is at least 0.20.

Examples of Tables of such interference colors were listed by J. Henrie, S. Kellis, S. M. Schultz and A. Hawkins in “Electronic color charts for dielectric films on silicon”, Optics Express 12, 1464-1469 (2004).

Because of the sensitivity of the eye, visual assessment in the visible part of the spectrum (400 nm-700 nm) is very meaningful. For the assessment, the interference colours could, in principle, also be recorded by a spectrometer. This method would, however, only have an advantage in the case where interference colours lying above or below the region visible by the human eye would occur or where multiple-beam interference would overcharge the spectral resolution of the human eye.

### Results

Assessments of the interference colors of samples determined as described by the test methods are listed in Table 7.

TABLE 7

| | Thickness of the non- | Occurrence of | |
|---|---|---|---|
| Example | porous polymer layer | interference | |
| No. | (nm) | colours | Colour |
| 1 | 200-240 | very pronounced | violet |
| 2 | 950-1000 | pronounced | green |
| 3 | 500-540 | pronounced | blue-green |

The results of Table 7 clearly show that pronounced, well visible interference colors occur in all cases. They are very pronounced in Example 1.

Finally, variations from the examples given herein are possible in view of the above disclosure. Therefore, although the invention has been described with reference to certain preferred embodiments, it will be appreciated that other binders may be devised, which are nevertheless within the scope and spirit of the invention as defined in the claims appended hereto.

The foregoing description of various and preferred embodiments of the present invention has been provided for purposes of illustration only, and it is understood that numerous modifications, variations and alterations may be made without departing from the scope and spirit of the invention as set forth in the following claims.

1. Flexible material for optical applications in a wavelength range of λ₁ to λ₂, λ₁ being smaller than λ₂, composed of a flexible support and at least one multilayer that comprises a porous or nanoporous layer having a low refractive index and contains inorganic nanoparticles and at least one binder, and a non-porous polymer layer having a high refractive index and which is in direct contact with the porous or nanoporous layer, wherein the maximum thicknesses of the boundary layers, in which the refractive index changes from one value to the other and which are located between the porous or nanoporous layers and the non-porous polymer layers that are in direct contact, amount to maximally 0.2 times wavelength λ₂.

2. Material according to claim 1, wherein λ₁ is above 200 nm and λ₂ is below 2500 nm.

3. Material according to claim 1, wherein the difference of the refractive indices of the porous or nanoporous layer and the non-porous polymer layer is at least 0.20 in the wavelength range λ₁ to λ₂.

4. Material according to claim 1, wherein the material has one multilayer on the support.

5. Material according to claim 4, wherein there is a second multilayer on top of the first multilayer.

6. Material according to claim 5, wherein the sequence of the layers in the second multilayer is the same as in the first multilayer.

7. Material according to claim 5, wherein the sequence of the layers in the second multilayer is opposite to the sequence in the first multilayer.

8. Material according to claim 1, wherein the porous or nanoporous layer of the first multilayer is in direct contact with the support.

9. Material according to claim 1, wherein the non-porous polymer layer of the first multilayer is in direct contact with the support.

10. Material according to claim 1, wherein the dry thicknesses of the porous or nanoporous layers are from 0.2 μm to 60 μm and the dry thicknesses of the non-porous polymer layers are from 0.05 μm to 2.5 μm.

11. Material according to claim 1, wherein the inorganic nanoparticles are selected from the group consisting of precipitated or fumed silicium dioxide, aluminum oxide, aluminum oxide/hydroxide, zeolite beta, zeolite ZSM-5, zeolite mordenite, zeolite LTA (Linde type A), zeolite faujasite and zeolite LTL (Linde type L) or mixtures of these compounds.

12. Material according to claim 11, wherein the inorganic nanoparticles have a mean particle diameter between 5 nm and 200 nm.

13. Material according to claim 1, wherein the amount of binder in the porous or nanoporous layer containing inorganic nanoparticles is from 0.5 percent by weight to 60 percent by weight relative to the amount of nanoparticles contained in this layer.

14. Material according to claim 1, wherein the binder in the porous or nanoporous layer is selected from the group consisting of modified and non-modified polyvinyl alcohol, polyvinyl pyrrolidone or mixtures of these compounds.

15. Material according to claim 1, wherein the polymer in the non-porous polymer layer is selected from the group consisting of modified polyvinyl alcohol, polyurethane, (meth)acrylated polybutadiene, copolymers of (meth)acrylamide and polyacrylnitrile or mixtures of these compounds.

16. Material according to claim 1, wherein the non-porous polymer layer consists of water dispersible thermoplastic polymers having glass transition temperatures between 30° C. and 170° C., and where the non-porous polymer layer is formed by a heat treatment under pressure.

17. Material according to claim 16, wherein the water dispersible thermoplastic polymers are selected from the group consisting of particles, latices or waxes of polyethylene, polypropylene, polytetrafluoroethylene, polyamides, polyesters, polyurethanes, acrylnitriles, polymethacrylates, polyacrylates, polystyrene, polyvinyl chloride, polyethylene terephthalate, copolymers of ethylene and acrylic acid and paraffin waxes.

18. Method of preparation of the materials according to claim 1, wherein the porous or nanoporous layer containing inorganic nanoparticles and the non-porous polymer layer are applied to the flexible support in two separate coating passes.

19. Method of preparation of the materials according to claim 18, wherein the flexible support is coated by the cascade or curtain coating process.
